(19) United States
(12) Patent Application Publication
(10) Pub. No.: US 2025/0111169 A1
(43) Pub. Date: Apr. 3, 2025

(54) MULTI-LARGE LANGUAGE MODEL SYSTEM AND METHOD

(71) Applicant: Verifai Inc., Palo Alto, CA (US)

(72) Inventors: Sandeep Srinivasan, Palo Alto, CA (US); Rohit Uday Suvarna, Jersey City, NJ (US); Ethan F. Matus, Saratoga, CA (US)

(21) Appl. No.: 18/900,078

(22) Filed: Sep. 27, 2024

Related U.S. Application Data
(60) Provisional application No. 63/586,299, filed on Sep. 28, 2023.

(51) Int. Cl. G06F 40/40; G06N 3/0895

(52) U.S. Cl. CPC G06F 40/40; G06N 3/0895

(57) ABSTRACT

Methods, systems, and devices for processing prompts by an array of large language models (LLMs). The system may provide the prompt to multiple LLMs. The multiple LLMs are trained on different datasets and have different knowledge and capabilities. The system receives multiple responses from the multiple LLMs, determines a rank for each of the multiple responses, the rank indicating a level of confidence of the corresponding response representing a ground truth, compares the ranks of the multiple responses, and selects the response having the best rank as the most probable ground truth response.

### CROSS-REFERENCE TO RELATED APPLICATIONS

The present application claims the benefit of U.S. Provisional Application Ser. No. 63/586,299 filed Sep. 28, 2023. The entire disclosure of the application listed is hereby incorporated by reference, in its entirety, for all that the disclosure teaches and for all purposes.

### FIELD OF THE INVENTION

The present invention is related generally to natural language processing and particularly to large language models.

### BACKGROUND

Natural language processing has witnessed remarkable advancements in recent years due to a proliferation of large language models (LLMs). LLMs can understand context, generate human-like text, and perform various language-related tasks with astonishing accuracy.

### BRIEF SUMMARY

In certain aspects, the present disclosure relates to a natural language processing system, device, and method supportive of self-evolving, AI-based language models, particularly LLMs.

In an embodiment, a system comprises a processor and a memory storing instructions thereon that, when executed by the processor, cause the processor to:
receive a prompt;
provide the prompt to multiple large language models (LLMs), the multiple LLMs being trained on different datasets and having different knowledge and capabilities;
receive multiple responses from the multiple LLMs;
determine a rank for each of the multiple responses, the rank indicating a level of confidence of the corresponding response representing a ground truth;
compare the ranks of the multiple responses; and
select the response having the best rank as the most probable ground truth response.

In an embodiment, a method comprises the steps:
receiving a prompt;
providing the prompt to multiple large language models (LLMs), the multiple LLMs being trained on different datasets and having different knowledge and capabilities;
receiving multiple responses from the multiple LLMs;
determining a rank for each of the multiple responses, the rank indicating a level of confidence of the corresponding response representing a ground truth;
comparing the ranks of the multiple responses; and
selecting the response having the best rank as the most probable ground truth response.

Additional features and advantages are described herein and will be apparent from the following Description and the figures.

### BRIEF DESCRIPTION OF THE SEVERAL VIEWS OF THE DRAWINGS

FIG. 1 is a block diagram of a language processing system in accordance with aspects of the present disclosure;

FIG. 2 is a block diagram of a language processing system in accordance with aspects of the present disclosure;

FIG. 3 is a block diagram of a ranking and reasoning engine in accordance with aspects of the present disclosure;

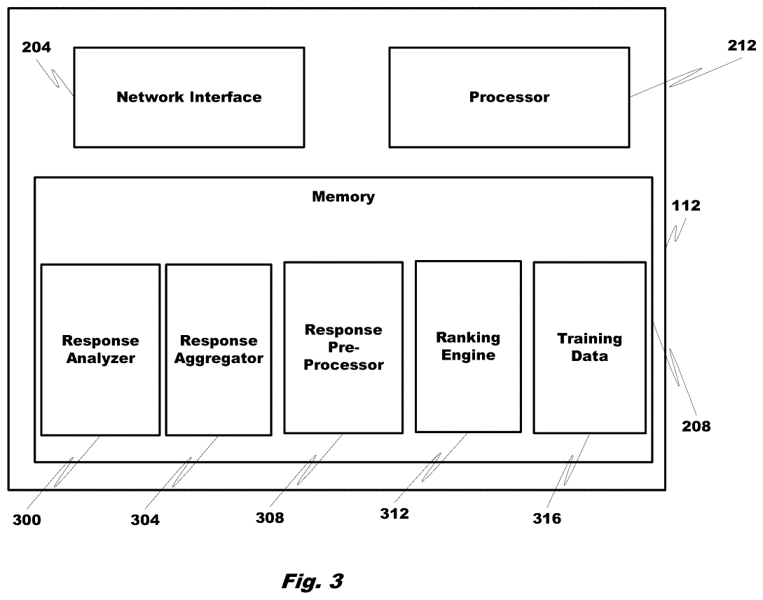

FIG. 4 is a block diagram of a prompt router in accordance with aspects of the present disclosure;

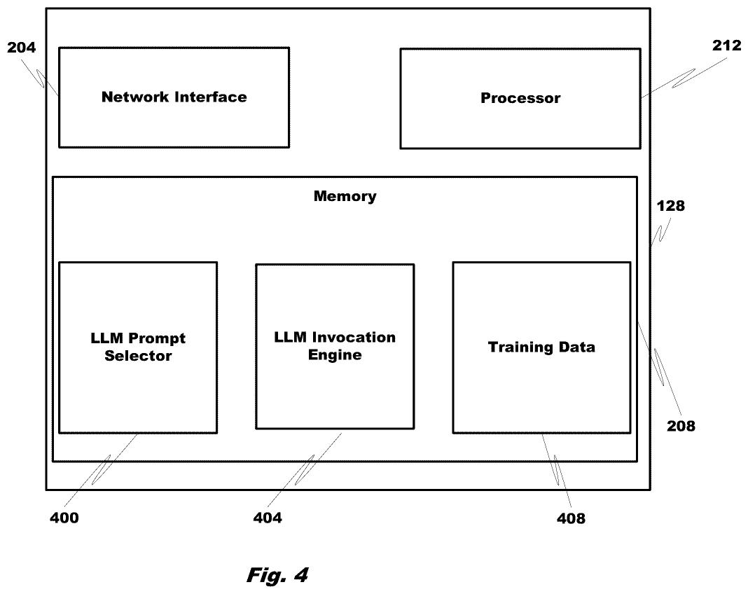

FIG. 5 is a process flow illustrating aspects of a self-evolving, AI-based prompt router in accordance with aspects of the present disclosure; and

FIG. 6 is a process flow illustrating aspects of a self-evolving, AI-based ranking and reasoning engine in accordance with aspects of the present disclosure.

### DESCRIPTION OF THE INVENTION

Aspects of the present disclosure will be described in connection with self-evolving, artificial intelligence (AI)-based natural language processing models hosted in an environment such as, for example, a cloud environment. The natural language models are typically implemented as an array of LLMs executing a selected prompt in parallel. The various outputs of the LLMs are analyzed and ranked by an AI-based ranking and reasoning engine, with the highest ranked output indicating the most probable best fit or optimal solution for the prompt and the lowest ranked output indicating the least probable best fit or optimal solution.

The present disclosure is directed to a network of interconnected servers, each of which comprises an LLM. The LLMs are all trained on different datasets and have different knowledge and capabilities. The LLMs are configured to communicate with each other. They can use the same or different AI algorithms. A selected segment of content can be provided simultaneously to plural of the host servers and corresponding LLMs to generate plural responses. The LLMs collaborate to generate a most accurate and informative response, such as measured by applying selected rules and other criteria. In some embodiments, a further AI engine can receive the multiple inputs from the LLMs and select an appropriate output. The multi-LLM concept can potentially revolutionize how humans interact with computers. By combining the knowledge and capabilities of multiple LLMs, the LLMs can create more intelligent, creative, and helpful systems than ever before.

The use of multiple different LLMs executing a prompt in parallel can address a technical problem of LLMs. While LLMs can understand context, generate human-like text and perform various language-related tasks accurately, LLMs can produce incorrect or misleading results, which is known LLM hallucination. For example, an LLM may generate factually incorrect information, such as claiming that Charles Lindbergh walked on the moon. An LLM may generate an output that contradicts the information provided in the input prompt. For example, if the prompt is “What is the capital city of France?”, the LLM may respond with “Berlin”. An LLM may mix up names or relations of entities. For example, if a user mentions that his or her friend John likes hiking and then says his or her uncle Mark is coming to visit, the LLM might incorrectly link John and Mark are visiting together. An LLM may produce an inaccurate summary of information. For example, ChatGPT may produce a factually inaccurate summary of a court case. LLMs can be prone to hallucinations because they rely on pattern recognition and statistics and lack common sense and factual knowledge. While LLM hallucination can be addressed through prompt engineering, model refinement (e.g., training the LLM on diverse and relevant data), and retrieval-augmented generation or RAG (e.g., augmenting the prompt with additional information to produce more relevant responses), such solutions can be expensive and only partially successful.

By currently invoking and managing multiple LLMs to execute a common prompt in parallel, the likelihood of LLM hallucination can be greatly reduced. Some LLMs in the LLM array will have a lower likelihood of providing an incorrect or misleading result output when compared to other LLMs in the array. By efficiently ranking and/or comparing the similarity of the output to yield an output having the highest likelihood of being the ground truth, LLM hallucination incidents can be reduced. By leveraging the capabilities of several LLMs together, complex tasks can be addressed more effectively than before. The LLMs generating less accurate output can beneficially be trained based on feedback from comparing the highest ranked output with the particular output generated by the corresponding LLM. In this manner, future occurrences of LLM hallucination can be reduced.

The use of multiple LLMs in parallel to produce responses that may be ranked and/or compared for levels of similarity or dissimilarity to determine a most probable ground truth response has the further benefit of dealing effectively with complex query resolution. When dealing with intricate queries or prompts, using a single LLM may not yield the most accurate or comprehensive results. By leveraging multiple LLMs simultaneously, a ranking and reasoning engine can enhance the quality of responses by aggregating insights from similar or dissimilar responses of different LLMs. Action chains may be used to pre-process the LLM responses using a sequence of actions and enable the LLM responses, that might not otherwise yield desired results, to be refined and enhanced resulting in more polished and relevant content. To reduce complexity, the ranking and reasoning engine can weight each response based on common factors and, by aggregating the weights for the plural factors into a single value, simplify selecting a response as the most probable ground truth response without compromising accuracy.

While the disclosure is discussed with reference to LLMs, it is to be understood that small language models or SLMs may be used alternatively to or in addition to LLMs. As will be appreciated, SLMs are a type of machine learning algorithm trained to understand and generate text. SLMs are typically more compact and efficient than LLMs due to smaller datasets, fewer parameters, simpler architecture, and greater computational efficiency. In addition to replacing LLMs in the LLM array, SLM functionality may be used for the prompt router and/or in the ranking and reasoning engine.

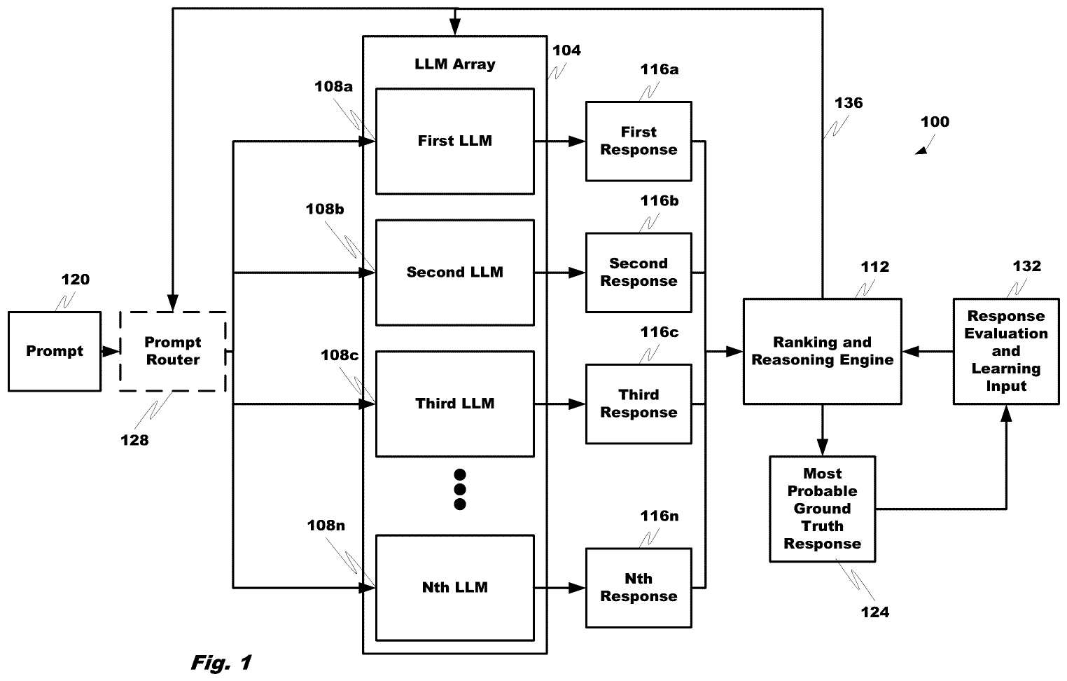

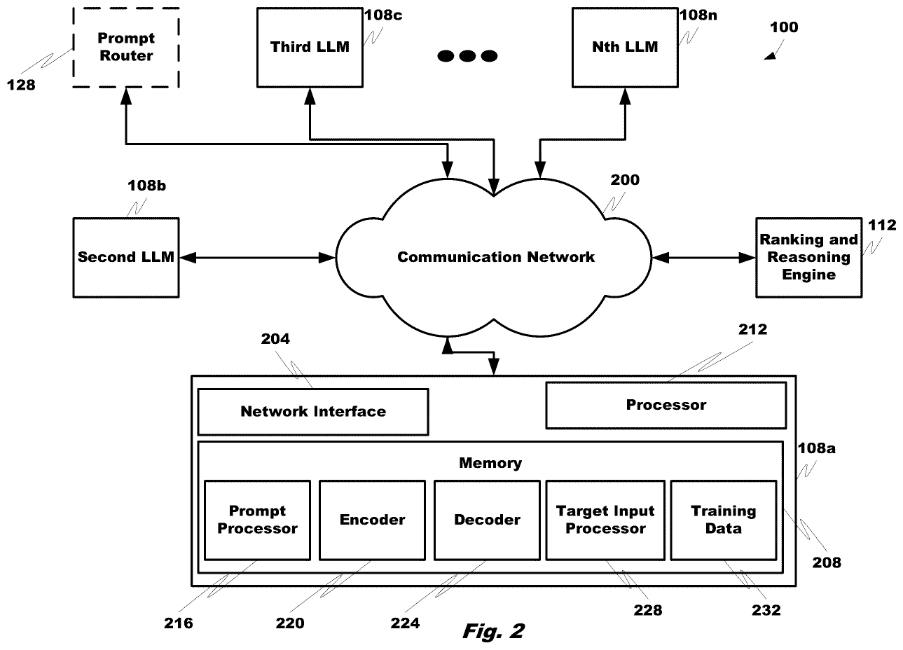

With reference to FIGS. 1 and 2, an embodiment of the natural language processing system 100 will be described. The system 100 comprises an LLM array 104 comprising first, second, third, . . . nth LLMs 108a-n, an optional prompt router 128 to analyze and direct a prompt to an appropriate subset of the LLMs in the array 104, a ranking and reasoning engine 112 processing appropriate ones of the first, second, third, . . . nth outputs 116a-n of the subset of the LLM array 104 to a receipt of the common prompt 120. As shown in FIG. 2, the various components can be communicatively connected by a network 200.

The prompt 120 can be a set of instructions, text, audio, images, video, or other input that instructs the model what to do and is the starting point for communication with the LLM. The prompt can indicate the output, including a desired format or type of output, the context, such as zero-shot, one-shot, and few-shot prompts, chain-of-thought prompting that encourages the LLM to produce intermediate reasoning steps to improve the results for complex tasks, and other commands. Exemplary types of prompts include direct instruction prompts, task completion prompts, few-shot learning prompts, story continuation prompts, and question-answering prompts.

The first, second, third, . . . nth LLMs in the array 104 can trained on different datasets and having different knowledge and capabilities. As will be appreciated, a large language model (LLM) is a type of artificial intelligence (AI) algorithm that uses deep learning techniques and massively large data sets to understand, summarize, generate and predict new content. LLMs are a type of generative AI that has been specifically architected to generate text-based content. The architecture of LLMs commonly includes multiple layers of neural networks, e.g., recurrent layers, feedforward layers, embedding layers, and attention layers. LLMs are commonly configured as artificial neural networks which can contain a billion to a trillion weights and are typically (pre-) trained using self-supervised and/or semi-supervised learning. A transformer architecture can enable faster training. Alternative architectures include a mixture of experts (MoE). The large size of LLMs can be enabled by AI accelerators, which are able to process vast amounts of text data, mostly scraped from the Internet. These layers work together to process the input text and generate output predictions. While any LLM can be used with this disclosure, LLM examples include OpenAI's GPT models (e.g., GPT-3.5 and GPT-4, used in ChatGPT), Gemini, Gemma, and LLaMa3, Claude 3, Phi3 etc.

Dataset pre-processing can use probabilistic tokenization. Using a modification of byte-pair encoding, in the first step, all unique characters (including blanks and punctuation marks and other grammar indicators) are treated as an initial set of n-grams (i.e. initial set of uni-grams). Successively the most frequent pair of adjacent characters is merged into a bi-gram and all instances of the pair are replaced by it. All occurrences of adjacent pairs of (previously merged) n-grams that most frequently occur together are then again merged into even lengthier n-gram repeatedly until a vocabulary of prescribed size is obtained (in case of GPT-3, the size is 50257). Token vocabulary consists of integers, spanning from zero up to the size of the token vocabulary. New words can always be interpreted as combinations of the tokens and the initial-set uni-grams.

A specific LLM implementation is shown in FIG. 2, though other implementations are possible. With reference to FIG. 2, the ranking and reasoning engine 112, optional prompt router 128, and first, second, third, . . . nth LLMs 108a-n in the array 104 is interconnected by a communication network 200, and each of the first, second, third, . . . nth LLMs 108a-n in the array 104 comprises a network interface 204, user interface 208, and processor 212 and in a computer readable memory 208, a prompt processor 216, an encoder 216, decoder 220, target input processor 228, and training data 224.

The communication network 200 interconnects and facilitates machine-to-machine communications between the first, second, third, . . . nth LLMs 108a-n, the optional prompt router 128, and the ranking and reasoning engine 112. It should be appreciated that the communication network 200 may correspond to one or many communication networks without departing from the scope of the present disclosure. In some embodiments, the various system components may be configured to communicate using various nodes or components of the communication network 104. The communication network 200 may include any type of known communication medium or collection of communication media and may use any type of protocols to transport messages between endpoints. The communication network 200 may include wired and/or wireless communication technologies. The Internet is an example of the communication network 200 that constitutes an Internet Protocol (IP) network consisting of many computers, computing networks, and other communication devices located all over the world, which are connected through many telephone systems and other means. Other examples of the communication network 200 include, without limitation, a standard Plain Old Telephone System (POTS), an Integrated Services Digital Network (ISDN), the Public Switched Telephone Network (PSTN), a Local Area Network (LAN), a Wide Area Network (WAN), a cellular network, and any other type of packet-switched or circuit-switched network known in the art. In addition, it can be appreciated that the communication network 200 need not be limited to any one network type, and instead may be comprised of a number of different networks and/or network types. Moreover, the communication network 200 may include a number of different communication media such as coaxial cable, copper cable/wire, fiber-optic cable, antennas for transmitting/receiving wireless messages, and combinations thereof.

The network interface 204 provides the corresponding LLM with the ability to send and receive communication packets or the like over the communication network 200. The network interface 204 may be provided as a network interface card (NIC), a network port, drivers for the same, and the like. Communications between the LLM or components of a server hosting the LLM and other devices connected to the communication network 200 may all flow through the network interface 204.

The processor 212 may correspond to one or many computer processing devices. For example, the processor 212 may be provided as silicon, as a Field Programmable Gate Array (FPGA), an Application-Specific Integrated Circuit (ASIC), any other type of Integrated Circuit (IC) chip, a collection of IC chips, a microcontroller, a collection of microcontrollers, or the like. As a more specific example, the processor 212 may be provided as a microprocessor, Central Processing Unit (CPU), or plurality of microprocessors that are configured to execute the instructions sets stored in memory 208. Upon executing the instruction sets stored in memory 208, the processor 212 enables various language processing functions of the LLM.

In some aspects, the natural language processing system 100 may be implemented using a fully software-based solution. In some other aspects, the system 100 may be implemented using a combination of software and hardware accelerators for offloading AI processing tasks and/or AI data handled at the system 100. Aspects of the present disclosure and solutions thereof may be used locally at a local server and/or on a cloud server. Example processors (also referred to herein as co-processors) usable for offloading the AI processing tasks and/or AI data may include any combination of GPUs, ASICs, FPGAs, or the like.

The memory 208 may include any type of computer memory device or collection of computer memory devices. The memory 208 may be volatile or non-volatile in nature and, in some embodiments, may include a plurality of different memory devices. Non-limiting examples of memory 208 include Random Access Memory (RAM), Read Only Memory (ROM), flash memory, Electronically-Erasable Programmable ROM (EEPROM), Dynamic RAM (DRAM), etc. The memory 208 may be configured to store the instruction sets depicted in addition to temporarily storing data for the processor 212 to execute various types of routines or functions. Although not depicted, the memory 208 may include instructions that enable the processor 212 to store data to and retrieve data from a database.

The memory 208 can store therein a set of instructions which, when executed by the processor 212, cause the processor 212 to perform the various functions of the LLM. For example, the memory 208 can have stored therein a set of prompt processing instructions 216 and target input processing instructions 228, which, when executed by the processor 212, can cause the processor 212 to transform the prompt or target input as appropriate into individual word tokens, convert the tokens sequence into input embeddings or high-dimensional vectors (often ranging from 128 to 1024 dimensions or more), and add positional encodings (which comprise positional encoding vectors to each tokenized set of information (e.g., words or commands) to define the relative positions of the corresponding information in the prompt or target input to the input embeddings to account for the sequential nature of prompt language and provide an interim output. The interim output corresponding to the prompt or target input typically comprises a single vector for each portion of the prompt or target input (e.g., each word) formed by summing an embedding vector and its context vector.

The memory 208 can have stored therein a set of encoder instructions 220 which, when executed by the processor 212, can cause the processor 212, to receive the interim output of the prompt processing instructions 216, capture by multiple parallel self-attention heads or layers different types of relationships and dependencies in the interim output (and assign a weight to each part of the interim output to indicate a level of importance of the selected input portion in context to the remainder of the interim output), perform layer normalization by one or more normalization layers and add the original embeddings to the self-attention head output via a skip connection (also known as a residual or shortcut connection), and, after entering a fully connected layer or small multilayer perceptron comprising two fully connected layers with nonlinear activation function in between, the outputs of the previous normalization stage are again added and again normalized before the encoder output is passed to the decoder instructions 224. The encoder instructions, when executed, understand and extract the relevant information form the interim output and outputs, as the encoder output, a continuous representation or embedding of the interim output for processing by the decoder instructions. Stated differently the encoder instructions can capture the contextual relationships between different portions of the prompt (e.g., words) and generate an attention vector for each prompt portion and, in some embodiments, a position-wise feed-forward network (e.g., a neural network) (FFN) is applied to each attention vector to transform it into a format expected by a next multi-head attention layer in the decoder instructions.

The memory 208 can have stored therein a set of decoder instructions 224 which, when executed by the processor 212, can cause the processor 212, to generate translated text or target language based on the continuous representation received from the encoder instructions and the interim output corresponding to the target input. The decoder instructions perform similar operations to the encoder instructions with the inputs and outputs being different. The decoder instructions typically comprise a masked multi-head attention layer, multi-head attention layer, and a position-wise feed-forward network. The multi-head self-attention layer in the decoder instructions and position-wise feed-forward network can be similar to the one in the encoder. The masked multi-head attention layer can mask portions of the prompt or target input by converting them to zeros to prevent the model from attending to future positions, ensuring that the predictions for position i can depend only on the known outputs at positions less than i. This masking can maintain the autoregressive property of the model during training and inference. The autoregressive property can ensure that the model generates output tokens one at a time and uses previously generated tokens as context for generating the next word token. As will be appreciated, masked language modeling can mask (or replace) random word tokens in the input sequence and train the model to predict the original masked tokens based on the surrounding context.

Variations of the above-described transformer model can be employed, such as encoder-only models (e.g., Bidirectional Encoder Representations from Transformers or BERT and Robustly optimized BERT approach or ROBERTa as non-limiting examples), decoder-only models (e.g., Generative Pre-trained Transformer or GPT and its successors ChatGPT, GPT-2, GPT-3, GPT-3.5, GPT-4, and GPT-40 as non-limiting examples are pretrained on large-scale unsupervised text data and finetuned for specific tasks such as text classification, sentiment analysis, question-answering, and summarization), and encoder-decoder hybrids (e.g., BERTas nonlimiting examples). As will be appreciated, encoder-only models are more effective in learning embeddings used in classification tasks, encoder-decoder models are more effective in generative tasks where the output heavily relies on the input (for example, translation and summarization), and decoder-only models are used for other types of generative tasks including question and answer applications.

While the above description is based on the transformer network model, or a neural network that learns context and meaning by tracking relationships in sequential data, it is to be appreciated that other types and models of LLMs and other language models may be employed in the array 104. For example, rule-based language models, statistical language processing models, N-gram models, neural network models (such as recurrent neural networks and long short-term memory networks), sequence-to-sequence models, pre-trained models, among others may be employed in the array in addition to or as part of the LLM.

The various LLMs 108a-n in the LLM array 104 are typically different from one another. The differences include one or more of model size and parameter account, input representations, self-attention mechanisms, training objectives, computational efficiency, training methodology and training data, and decoding and output generation. In some embodiments, the LLMs are open or closed source LLMs, general-purpose LLMs, domain-specific LLMs, multilingual LLMs, few-shot LLMs, and/or task-specific LLMs.

Applications for the LLMs in the LLM array 104 include content generation and curation (e.g., generating content such as text, audio, images, and videos, and the like); summarization, language translation and localization, classification, chatbot, medical diagnosis and image analysis, virtual assistants, programming code generation (e.g., source and/or machine code), sentiment analysis and market insight, detecting and preventing Cyber attacks, transcription, storytelling, sales automation, HR recruitment and candidate screening, to name a few.

The memory can also store therein training data 232. The neural network may support K-means clustering of training data 232. For example, the training data 232 may include data relating to the specific application selected for the corresponding LLM. In some embodiments, the training data 224 may include a labeled or unlabeled dataset and the neural network may implement a K-means algorithm which includes iteratively partitioning the dataset into K pre-defined, distinct, non-overlapping subgroups (also referred to herein as clusters) where each data point belongs to only one subgroup. In some cases, implementation of the K-means algorithm may include partitioning the dataset such that intra-cluster data points are as similar as possible (e.g., within a threshold criteria) while clusters are as different (e.g., far, in accordance with a threshold distance) as possible.

The ranking and reasoning engine 112 is a self-evolving, artificial intelligence (AI)-based model that analyzes the classifies the first, second, third, . . . nth responses 116a-n of the LLMs in the array 104 to select a response as the most probable ground truth 124. The ranking and reasoning engine comprises a network interface 204 (discussed above), processor 212 (discussed above), and memory 208 (discussed above). The memory 208 can store therein a set of instructions which, when executed by the processor 212, cause the processor 212 to perform the various functions of the engine. For example, the memory 208 can have stored therein a set of response analyzer instructions 300 to provide a framework for defining and executing actions that can be preprocess responses (such as by refining responses, extracting specific information, and/or applying transformations), set of response aggregator instructions 304 to modify and/or aggregate responses from different LLMs, a set of response pre-processing instructions 308 to pre-process individual or aggregated responses in a serial manner for LLM input, a set of ranking engine instructions 312 that rank the inputted responses with respect to the most probable ground truth response 124. and training data 316.

The response analyzer instructions 300, when executed by the processor 212, receives an action command or series or chain of sequential user-specified action commands that operate on each of the first, second, third, . . . nth responses to determine whether or not the response has at least a threshold probability of qualifying as the most probable ground truth response 124 or requires modification or refinement before being processed by the next layer or response aggregator instructions 304. In the former case, if the response does not have at least a threshold probability of qualifying as the most probable ground truth response 124, it would be discarded as a spurious result and not further processed. An example would be a response that purports to be executable code could be executed and, if not successfully executed, would be deemed to be a spurious result. In the latter case, if the response comprises irrelevant, incorrect, or inaccurate information, such information could be removed from the response before further processing to remove the deleterious effect of LLM hallucination from the ranking and reasoning engine ranking. An example would be a response that comprises executable code and non-executable code, with the non-executable code being modified or removed from the response before further processing. Another example would be applying a spell and/or grammar checker to a response to remove and/or correct any incorrectly spelled words or modify incorrect grammar.

The response aggregator instructions 304, when executed by the processor 212, can analyze selected sets of responses and, if each member of the selected set is suboptimal, combine (e.g., mix or match) selected portions of the member responses into an aggregated response that replaces one or more of the member responses in further processing by the ranking and reasoning engine 112. This operation can be particularly beneficial in dealing with intricate queries or prompts that yield divergent or widely different responses from the LLMs in the array 104. As an example, the prompt could define a requested sorting function to be provided for which the various LLM responses provide multiple divergent potential implementations. One of the sorting functions that is a sub-function or subroutine that would be useful in the sorting function of another response. The sorting function in the other response could be modified by the sub-function or subroutine to provide a modified response for further ranking and reasoning engine processing.

As will be appreciated, the response analyzer instructions 300 and/or response aggregator instructions 304 could be configured as an AI agent or fully or semi-autonomous intelligent system that performs specific tasks or actions without human intervention.

The response and target input pre-processing instructions 300, when executed by the processor 212, can cause the processor 212, to pre-process the responses and target inputs (e.g., ranking criteria) in a serial manner for input into the ranking engine 312. In an embodiment, the set of response and target input pre-processing instructions 300 cause the processor 212 to receive each of the first, second, third, . . . nth responses 116a-n (or responses derived therefrom as previously described) and target inputs, transform the response or target input into individual word tokens, convert the token sequence into input embeddings or high-dimensional vectors (often ranging from 128 to 1024 dimensions or more), and add positional encodings (which comprise positional encoding vectors to each tokenized set of information (e.g., words or commands) to define the relative positions of the corresponding information in the response or target input to the input embeddings to account for the sequential nature of target input language and provide an interim output corresponding to the pre-processed response to target input. The interim output typically comprises a single vector for each portion of the prompt (e.g., each word) formed by summing an embedding vector and its context vector.

The ranking engine instructions 304, when executed by the processor 212, can cause the processor 212, to rank the interim outputs corresponding to the various responses to identify the most relevant information and most probable ground truth response 124. The ranking of the interim outputs can be based on predetermined criteria relevant to the particular application. Exemplary criteria include space complexity (e.g., the amount of memory an algorithm uses to execute, measured as a function of the input size), time complexity (e.g., measures the amount of time an algorithm takes to run, also as a function of the input size), space-time complexity (e.g., a combined analysis of both the memory usage and execution time of an algorithm when considering different input sizes), clarity (e.g., clarity of the response), maintainability (e.g., response maintainability particularly when the response is source or machine code), algorithmic complexity (e.g., level of complexity of the algorithm in the response), readability (e.g., readability score which is a measure of the number of words in a sentence and a number of letters or syllables per word), efficiency (e.g., a measure of how well an algorithm performs in terms of time and space requirements), reusability (e.g., the ability to use the same algorithm multiple times without rewriting it), extensibility (e.g., the ability of an algorithm to adapt to new requirements, changes, or scenarios without compromising its functionality, performance, or quality), functional correctness (e.g., evaluates the accuracy of natural language-to-code generation tasks when the LLMs is tasked with generating code for a specific task in natural language), reference-based metrics (e.g., comparing the response to the source prompt) (such as N-gram based metrics, MMLU (Multi-task Language Understanding on MMLU), BLEU (bilingual evaluation understudy) score, Rouge (recall-oriented understudy for gisting evaluation) evaluation metric, Rouge-N metric, Levenshtein Similarity Ratio, and sematic similarity metrics (e.g., BERTScore, MoverScore, and Sentence Mover Similarity)), reference-free metrics (e.g., quality-based metrics, entailment-based metrics, and factuality, QA and QG-based metrics), and rule-based metrics (e.g., syntax correctness, format check, language check, and keyword presence), among others. In some cases, each of the responses is assigned an aggregate score, or weight indicating a probability that the response is the most probable ground truth 124. In some cases, each of the predetermined criteria is assigned a separate score and the individual scores are combined in some manner (e.g., average, mean, median, mode, summation, etc.) to provide the aggregate score for the response. The ranking engine instructions 312 then compare the various scores assigned to the responses against each other to select the response having the highest aggregate score.

In some embodiments, the ranking and reasoning engine 112 is configured as an LLM having the same components as the first LLM 108a discussed above in connection with FIG. 2. In this configuration when the ranking engine 304 comprises an encoder set of instructions, the processor 212 receives the interim output of the response pre-processing instructions, captures by multiple parallel self-attention heads or layers different types of relationships and dependencies in the interim output (and assigns a weight to each part of the interim output to indicate a level of importance of the selected input portion in context to the remainder of the interim output), performs layer normalization by one or more normalization layers and adds the original embeddings to the self-attention head output via a skip connection (also known as a residual or shortcut connection), and, after entering a fully connected layer or small multilayer perceptron comprising two fully connected layers with nonlinear activation function in between, again adds the outputs of the previous normalization stage and normalizes before the encoder output is passed to decoder instructions if any. The encoder instructions, when executed, understand and extract the relevant information from the interim output and outputs, as the encoder output, a continuous representation or embedding of the interim output for processing by the decoder instructions. Stated differently the encoder instructions can capture the contextual relationships between different portions of the response (e.g., words) and generate an attention vector for each prompt portion and, in some embodiments, a position-wise feed-forward network (e.g., a neural network) (FFN) is applied to each attention vector to transform it into a format expected by a next multi-head attention layer in the decoder instructions.

When the ranking engine 304 comprises a decoder set of instructions, the processor 212 generates translated text or target language based on the continuous representation received from the encoder instructions and the target (e.g., a criteria noted above) after conversion by pre-processing instructions 300 into second the interim output different from the interim output provided to the encoder. The decoder instructions perform similar operations to the encoder instructions with the inputs and outputs being different. The decoder instructions can include a masked multi-head attention layer, multi-head attention layer, and a position-wise feed-forward network. The multi-head self-attention layer in the decoder instructions and position-wise feed-forward network can be similar to the one in the encoder. The masked multi-head attention layer can mask portions of the prompt or target input by converting them to zeros to prevent the model from attending to future positions, ensuring that the predictions for position i can depend only on the known outputs at positions less than i. This masking can maintain the autoregressive property of the model during training and inference. The autoregressive property can ensure that the model generates output tokens one at a time and uses previously generated tokens as context for generating the next word token. As will be appreciated, masked language modeling can mask (or replace) random word tokens in the input sequence and train the model to predict the original masked tokens based on the surrounding context.

As will be appreciated, the LLM configuration of the ranking engine can assign weights or probabilities to each criterion in parallel or sequentially followed by transformation of the assigned weights or probability into a single value to enable more efficient ranking of the responses relative to one another. The response having the highest probability of being ground truth is selected as the most probable ground truth response.

The LLM configuration of the ranking engine can also compare and assign a level of pair-wise similarity or dissimilarity between selected pairs of responses from the LLM array. This can be done by comparing the embedding vectors generated from the selected pair of responses to determine a level of agreement or disagreement between the responses and source LLMs. This can be done for all possible pairings of LLM responses. As will be appreciated, cosine similarity is a mathematical metric that measures how similar two vectors are in a multi-dimensional space. Cosine similarity can be used to compare the vector embeddings of an input such as a prompt or an output, such as a response, to that of a reference input. A high cosine similarity score indicates that the prompt or output is more similar to the reference input. Cosine similarity can be used to evaluate bow well an LLM understands a prompt and generates a response.

Cosine similarity scoring can also be applied to determine the ground truth for a given prompt. Majority voting may be based on clustering into groups the responses having at least a threshold level of similarity to each other. The memberships of the various groups of responses can be compared and the response associated with the group having the highest number of members is deemed to have the highest likelihood of being the ground truth and therefore can be selected as the most probable ground truth result.

Cosine similarity may also be used by the ranking engine to compare the similarity of each selected response to each criterion applied in the ranking of the response. Embedding vectors of the selected response and criterion description can be compared and assigned a cosine similarity score, which may be employed as the weight or rank assigned to the criterion.

Majority voting or ranking value comparison can be used alone or in conjunction with each other to determine the most probable ground truth response. Stated differently, the response having the highest ranking value and largest membership of similar responses has the highest likelihood of representing ground truth. Conversely, the response having the highest ranking value and largest membership of similar responses has the bigbest likelihood of representing ground truth. When the membership and ranking comparisons give different indications of which associated response has the highest likelihood of representing ground truth, one of the other of the indicators can be more heavily weighted as the tie-breaker depending on the application.

The memory can also store therein training data 316. The neural network may support K-means clustering of training data 316. For example, the training data 316 may include response evaluation and learning input 132, which is data defining, measuring, or otherwise relating to the difference of the response selected as the most probable ground truth response 124 from ground truth for the source prompt. In some embodiments, the training data 316 includes pre-training data that may include a labeled or unlabeled dataset and the neural network may implement a K-means algorithm which includes iteratively partitioning the dataset into K pre-defined, distinct, non-overlapping subgroups (also referred to herein as clusters) where each data point belongs to only one subgroup. In some cases, implementation of the K-means algorithm may include partitioning the dataset such that intra-cluster data points are as similar as possible (e.g., within a threshold criteria) while clusters are as different (e.g., far, in accordance with a threshold distance) as possible.

The optional prompt router 128 is a self-evolving, artificial intelligence (AI)-based model that selects a subset of LLMs in the array 104 and orchestrates the concurrent and parallel execution of the common prompt 120 by the LLMs in subset. As in the case of the ranking and reasoning engine 112, the prompt router 128 comprises a network interface 204 (discussed above), processor 212 (discussed above), and memory 208 (discussed above). The memory 208 can store therein a set of instructions which, when executed by the processor 212, cause the processor 212 to perform the various functions of the prompt router. For example, the memory 208 can have stored therein a set of LLM prompt selector instructions 400 to analyze the source prompt 120 and select a subset of LLMs in the array 104 providing at least a threshold likelihood of providing the most probable ground truth response 124, a set of LLM invocation engine instructions that orchestrate the concurrent execution of multiple language models, and training data 408.

The set of LLM prompt selector instructions 400, when executed by the processor 212, cause the processor 212 to classify the source prompt into a predetermined category and map the category to a subset of LLMs in the array that are most likely or most capable of providing a most probable ground truth response. The set of LLM prompt selector instructions 400 can itself be implemented as an LLM configured to analyze and classify the source prompt into an appropriate category specifically tailored to the target output for the prompt 124 followed by selecting, based on the assigned category, the subset of LLMs to process the prompt 124. In an embodiment of this configuration, the various potential classifications are supplied to the LLM as target input and the prompt as prompt input. The various processing layers of the LLM noted above provide a list of potentially applicable classifications with an associated weight or probability that the classification correctly classifies the prompt. The classification having the highest probability is selected as the correct classification and is then mapped against a corresponding subset of LLMs most capable of handling prompts falling into the selected classification.

The set of LLM invocation engine instructions, when executed by the processor 212, employ a base LLM class set of attributes and methods that apply globally to multiple LLMs in the array 104 and therefore provides a structured foundation for implementing specific language model classes and a multi-LLM class that, unlike the base LLM class, is LLM customizable to provide a set of attributes and methods specifically tailored to each LLM and not universally applicable to one or more other LLMs in the array 104. The base LLM and multi-LLM classes can be used to define and load LLMs from a configuration file and run them in parallel to provide parallel responses 116a-n.

The memory can also store therein training data 408. The neural network may support K-means clustering of training data 408. For example, the training data 408 may include feedback 136, which can include the response evaluation and learning input 132, which indicates a level of effectiveness of the selected subset of LLMs in providing the most probable ground truth response 124 from ground truth for the source prompt. As shown in FIG. 1, the same feedback can be provided to each LLM in the selected subset to indicate a level of success of each LLM in providing a response qualifying as the most probable ground truth response and a reason why the response of each such LLM was or was not chosen as the most probable ground truth response 124. In some embodiments, the training data 408 includes pre-training data that may include a labeled or unlabeled dataset and the neural network may implement a K-means algorithm which includes iteratively partitioning the dataset into K pre-defined, distinct, non-overlapping subgroups (also referred to herein as clusters) where each data point belongs to only one subgroup. In some cases, implementation of the K-means algorithm may include partitioning the dataset such that intra-cluster data points are as similar as possible (e.g., within a threshold criteria) while clusters are as different (e.g., far, in accordance with a threshold distance) as possible.

In some embodiments, the prompt router 128 and ranking and reasoning engine 112 are hosted on the same or different servers.

According to example aspects of the present disclosure, the processor 212 may utilize one or more self-evolving or self-learning data models stored in memory 208. The data model(s) 142 may be provided in any number of formats or forms In one implementation, a data model is stored in the memory 208 as a neural network. The neural network may be, for example, a machine learning network and may include a machine learning architecture. In some aspects, the neural network may be or include an artificial neural network (ANN). In some other aspects, the neural network may be or include any machine learning network such as, for example, a deep learning network, a convolutional neural network, a long-short term memory (LSTM) neural network, or the like. Some or all of instructions or instruction sets stored in the memory 208 and some functions of the prompt router and ranking and reasoning engine may be implemented using machine learning techniques. In some cases, the machine learning techniques may include deep learning and reinforcement learning. Aspects of the present disclosure support modifying any portion of the neural network over time based on the response evaluation and learning input 132 as described herein.

The various LLMs can be trained by any suitable technique. For example, the LLMs can be trained using unsupervised learning. With unsupervised learning techniques (such as zero-shot and few-shot learning), the LLMs can learn previously unknown patterns in data using unlabeled datasets and avoid the need for extensive data labeling. In other applications, the LLMs are fined tuned using machine learning, such as reinforcement learning from human feedback through algorithms, such as proximal policy optimization, self-instruct approaches, and/or prompt engineering. To find out which tokens are relevant to each other within the scope of the context window, the attention mechanism calculates “soft” weights for each token, more precisely for its embedding, by using multiple attention heads, each with its own “relevance” for calculating its own soft weights. Length of a conversation that the model can take into account when generating its next answer is limited by the size of a context window. A model may be pre-trained either to predict how the segment continues, or what is missing in the segment, given a segment from its training dataset. It can either be autoregressive (i.e. predicting how the segment continues) or masked. The models can be customized using several techniques to achieve higher accuracy. Some techniques include prompt tuning, fine-tuning, and adapters.

According to example aspects of the present disclosure, the ranking and reasoning engine and prompt router may use modeling algorithms (e.g., random forest models, neural network, other modeling algorithms, etc.) for training of decision points of the data models described herein. In some aspects, the ranking and reasoning engine and prompt router may support incorporating additional models as additional data (e.g., additional or new research) for increasing the efficiency and accuracy associated with predictions by the data models.

A number of examples will be discussed to illustrate the joint operation of the LLM array 104 and the ranking and reasoning engine.

In a first example, the MultiLLM class was asked to generate code from two LLMs, namely BARD (precedes Gemini) and GPT and to compare the results. The responses are shown below:

```
BARD Response
def newton(ƒ, dƒ, x0, [symbol]    , maxiter [symbol]   100):

[symbol]

  Find a root of the function ƒ using Newton's method.
  Args:
    ƒ: The function to find a root of.
    dƒ: The derivative of ƒ.
    x0: The initial guess for the root.
    tol: the tolerance for convergence.
    maxiter: The maximum number of iterations to perform.
  Returns:
    the root of ƒ, or None if no root was found.

[symbol]

  for i in range(maxiter):
    x1 [symbol]     x0 [symbol]     ƒ(x0) [symbol]     dƒ(x0)
    if abs(x1 [symbol]     x0) [symbol]     tol:
      return x1
    x0 [symbol]     x1
  return None
GPT 1
def newton_method(ƒ, ƒ_prime, initial_guess, tol [symbol]   1e [symbol]   6, max_iter [symbol]   100):

[symbol]

  Newton's method for finding the root of a function.
  Parameter:
    ƒ (function): The function for which the root is to be found.
    ƒ_prime (function): the derivative of ƒ.
    initial_guess (float): The initial guess for the root.
    tol (float): The desired tolerance (default 1e−6).
    max_iter (int): The maximum number of iterations (default 100).
  Returns:
    float: The root found by Newton's method, or None if no root is found.

[symbol]

  x = initial_guess
  for _ in range(max_iter):
    ƒx = ƒ(x)
    if abs(ƒx) < tol:
      return x
    ƒpx = ƒ_prime(x)
    if ƒpx == 0:
      return None
    x [symbol]     ƒx / ƒpx
  return None [symbol]
indicates data missing or illegible when filed
```

The output of the ranking and reasoning engine after processing the above responses is as set forth below:
“The GPT implementation of the Newton's method function (newton_method) is well-documented with the clear parameter explanations and return format. It also includes appropriate input validation checks and handles the case when the derivative is 0. Overall, it is a comprehensive and robust implementation.”
“The BARD implementation of the Newton's method function (newton) is also well-documented and accepts the necessary parameters. However, it lacks input validation checks, such as when the derivative is 0, and does not provide an explicit return value when no root is found. It can be improved by addressing these limitations.”

“Based on these factors. I would rank GPT higher than BARD in terms of the clarity, completeness, and robustness of the implementation.”

In a second example, the MultiLLM class was asked to write a function to detect prime numbers, namely BARD and GPT and to compare the results. The responses fare shown below:

```
BARD Response:
  def is_prime(n): [symbol]
  Returns True if n is prime, False otherwise. [symbol]
  if n < 2:
    return False
  for i in range(2, int(n ** 0.5) + 1):
    if n % i = = 0:
    return False
  return True
GPT Response:
  def is_prime(number):
  if number < 2:
    return False
  for i in range(2, int(number**0.5) + 1):
    if number % i = = 0:
      return False
  return True
```

[symbol]

indicates data missing or illegible when filed

The output of the ranking and reasoning engine after processing the above responses is as set forth below:

### MultiLLM Explanation and Ranking for Example 2:

“BARD's implementation of the isprime function is identical to GPT's implementation. Both functions check if a number is prime using the same algorithm. Therefore, both LLMs share the same ranking.”
“GPT's implementation of the isprime function is correct and follows the standard algorithm for checking prime numbers. While the implementation is identical to BARD's, it still demonstrates proficiency in coding logic and knowledge of basic mathematical operations.”

In a third example, the MultiLLM class was asked to write a function to detect prime numbers, namely BARD and GPT and to compare the results. The responses fare shown below:

```
GPT Response
  def binary_sort(arr):
    if len(arr) <= 1:
      return arr
    mid = len(arr) // 2
    left_half = arr[ [symbol]   mid]
    right_half = arr[mid:]
    left_half = binary_sort(left_half)
    right_half = binary(sort(right_half)
    return merge(left_half, right_half)
  def merge(left, right):
    merged = [ ]
    i = j = 0
    while i < lens(left) and j < len(right):
      if left[i] < right[j]:
        merged.append[left[i])
        i += 1
      else:
        merged.append(right[j])
        j += 1
    while i < len(left):
      merged.append(left[i])
      i += 1
    while j < len(right):
      megred.append{right[j])
      j += 1
    return merged
BARD Response
  def binary_search(array, target):
    left = 0
    right = len(array) [symbol]     1
    while left <= right:
    mid = (left + right) // 2
    if array[mid] = = target:
      return mid
    elif array[mid] < target:
      left = mid + 1
    else:
      right = mid [symbol]     1
    return −1
```

[symbol]

indicates data missing or illegible when filed

The output of the ranking and reasoning engine after processing the above responses is as set forth below:

### MultiLLM Explanation and Ranking for Example 3:

“The GPT solution implements a recursive approach to merge sort. It splits the array into smaller halves, sorts them recursively, and then merges the sorted halves. This approach has a time complexity of 0(n log n) and is efficient for large datasets.”
“The BARD solution implements a binary search algorithm. It searches for a target value in a sorted array by repeatedly dividing the search space in half. This algorithm has a time complexity of 0(log n) and is efficient for finding a specific element in a sorted array. The implementation is correct and returns the index of the target if found, or −1 if not found. However, it does not involve ranking or sorting other LLMS, which is the task at hand.”

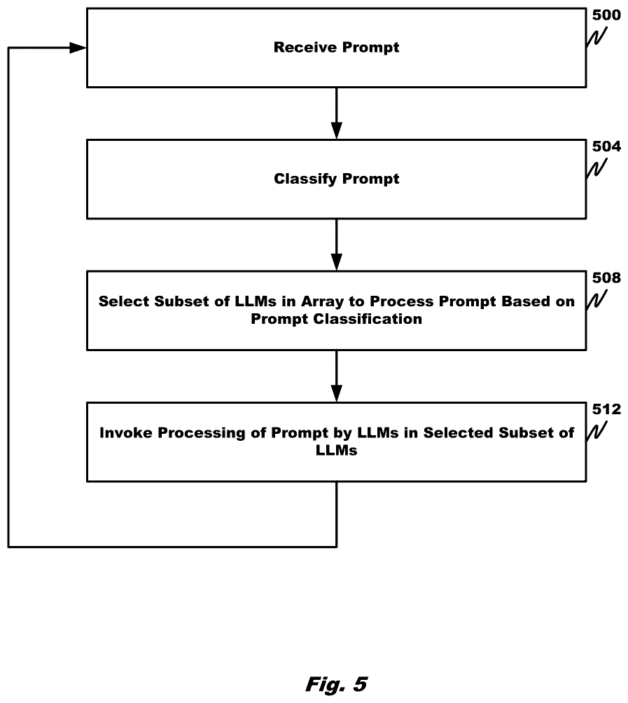

With reference now to FIG. 5, a method of operating the prompt router will be described in accordance with embodiments of the present disclosure.

The method begins in step 500 with the prompt router 128 receiving a prompt from a user or other computational component.

The method may continue in step 504 by the prompt router analyzing and classifying the prompt into one of multiple potential classifications.

The method continues in step 508 by the LLM prompt selector instructions 400 in the prompt router selecting a subset of LLMs in the array 104 to process the prompt based on the assigned prompt classification.

The method continues in step 512 by the LLM invocation engine 404 in the prompt router invoking simultaneous processing of the prompt by the LLMs in the selected subset of LLMs.

The prompt router returns to step 500 to await receipt of a next prompt.

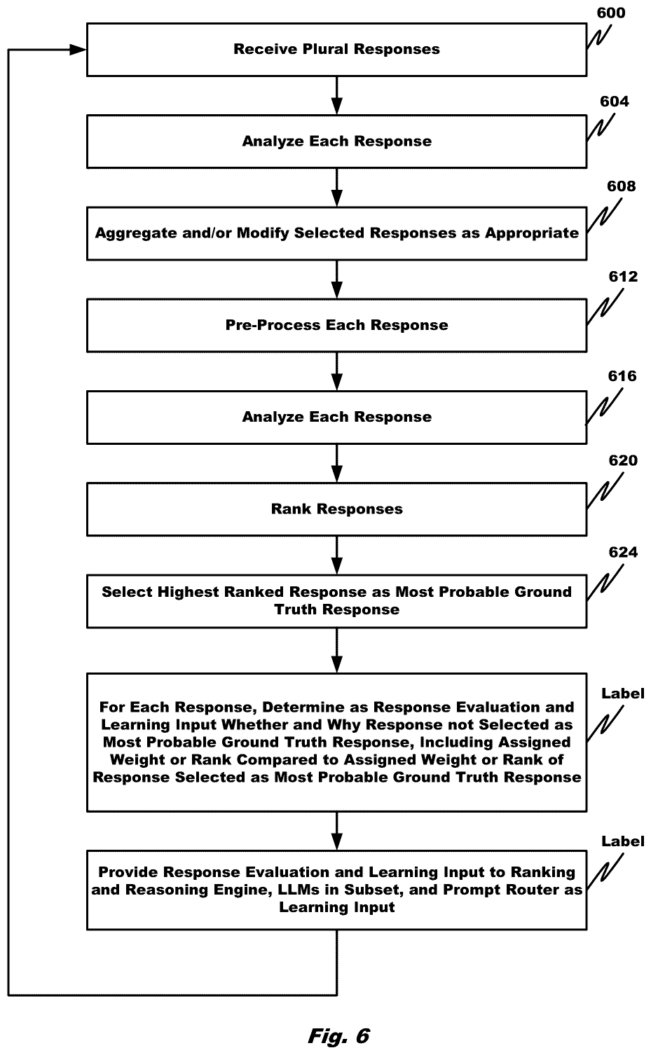

With reference now to FIG. 6, a method of operating the ranking and reasoning engine 112 will be described in accordance with embodiments of the present disclosure.

The method begins in step 600 by the engine 112 receiving a plurality of responses from the selected subset of LLMs.

The method may continue in step 604 by the response analyzer instructions 300 in the engine 112 analyzing each response.

The method may continue in step 608 by the response aggregator instructions 304 in the engine 112 aggregating and/or modifying one or more selected responses of the plurality of responses as appropriate.

The method may continue in step 612 by the response pre-processor instructions 308 in the engine 112 pre-processing each response (including any aggregated or modified response) for input into the ranking engine 312.

The method may continue in step 616 by the ranking engine instructions 312 in the engine 112 analyzing each response (e.g., the encoder layer forming a continuous representation of the response).

The method may continue in step 620 by the ranking engine instructions 312 assigning a weight or rank to the response (e.g., the decoder layer applying a selected inputted criterion to the continuous representation of the response to determine a weight for the selected inputted criterion).

The method may continue in step 624 by the ranking and reasoning engine selecting a highest ranked response as the most probable ground truth response.

The method may continue in step 628 by the ranking and reasoning engine determining, for each weighted response, a response evaluation and learning input 132. In some embodiments, the response evaluation and learning input 132 comprises an assigned weight or rank of the corresponding response compared to the assigned weight or rank of the response selected as the most probable ground truth response, which is supplied to the LLM producing the corresponding response and the prompt router as feedback for self-learning. The appropriate input 132 is subsequently provided to each LLM in the selected subset. In some embodiments, the response evaluation and learning input 132 comprises an indication of a level of similarity or dissimilarity between the most probable ground truth response and the ground truth. This input 132 can be subsequently provided to the ranking and reasoning engine as feedback for self-learning.

The method may continue in step 632 by the ranking and reasoning engine providing the appropriate input 132 to the LLMs and prompt router or the ranking engine 312 in the form or expression described above.

As should be appreciated by one skilled in the art, aspects of the present disclosure have been illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “circuit,” “module,” “component,” or “system.” Furthermore, aspects of the present disclosure may take the form of a computer program product embodied in one or more computer readable media having computer readable program code embodied thereon.

Any combination of one or more computer readable media may be utilized as the memory. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C #, VB.NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Aspects of the present disclosure have been described herein with reference to flowchart illustrations and/or block diagrams of methods, apparatuses (systems) and computer program products according to embodiments of the disclosure. It should be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

The term “a” or “an” entity refers to one or more of that entity. As such, the terms “a” (or “an”), “one or more,” and “at least one” can be used interchangeably herein. It is also to be noted that the terms “comprising,” “including,” and “having” can be used interchangeably.

A number of variations and modifications of the invention can be used. It would be possible to provide for some features of the invention without providing others.

The present invention, in various embodiments, configurations, or aspects, includes components, methods, processes, systems and/or apparatus substantially as depicted and described herein, including various embodiments, configurations, aspects, subcombinations, and subsets thereof. Those of skill in the art will understand how to make and use the present invention after understanding the present disclosure. The present invention, in various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving case and/or reducing cost of implementation.

The foregoing discussion of the invention has been presented for purposes of illustration and description. The foregoing is not intended to limit the invention to the form or forms disclosed herein. In the foregoing Detailed Description for example, various features of the invention are grouped together in one or more embodiments, configurations, or aspects for the purpose of streamlining the disclosure. The features of the embodiments, configurations, or aspects of the invention may be combined in alternate embodiments, configurations, or aspects other than those discussed above. This method of disclosure is not to be interpreted as reflecting an intention that the claimed invention requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate preferred embodiment of the invention.

Moreover, though the description of the invention has included description of one or more embodiments, configurations, or aspects and certain variations and modifications, other variations, combinations, and modifications are within the scope of the invention, e.g., as may be within the skill and knowledge of those in the art, after understanding the present disclosure. It is intended to obtain rights which include alternative embodiments, configurations, or aspects to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. A system comprising:
a processor; and
a memory storing instructions thereon that, when executed by the processor, cause the processor to:
receive a prompt;
provide the prompt to multiple large language models (LLMs), the multiple LLMs being trained on different datasets and having different knowledge and capabilities;
receive multiple responses from the multiple LLMs;
determine a rank for each of the multiple responses, the rank indicating a level of confidence of the corresponding response representing a ground truth;
compare the ranks of the multiple responses; and
select the response having the best rank as the most probable ground truth response.

2. The system of claim 1, wherein the multiple LLMs execute the prompt in parallel, wherein the prompt is a command to perform one or more of the following: generate text, generate machine coding, provide a response to a query, translate to a different language, and generate creative content, and wherein the processor:
select the multiple LLMs from among a larger plurality of LLMs based on analysis of the prompt.

3. The system of claim 1, wherein the rank comprises a cosine similarity score and wherein in determining the rank the processor:
transform the prompt into a plurality of vectors, each vector corresponding to a portion of the prompt and being derived from an embedding vector and a context vector;
transform, by one or more multiple parallel self-attention layer and normalization layers, the plurality of vectors into a continuous representation of the prompt;
transform, by a masked multi-head attention layer, multi-head attention layer, and position-wise feed-forward network, the continuous representation into an output comprising a weight associated with a selected ranking criterion for the response.

4. The system of claim 3, wherein each response is ranked based on a plurality of criteria, wherein each criterion of the plurality of criteria is assigned a weight, wherein the ranking for a selected response is derived from the weights assigned to the plurality of criteria, and wherein the plurality of criteria comprise a plurality of space complexity, time complexity, space-time complexity, clarity, maintainability, algorithmic complexity, readability, efficiency, reusability, extensibility, functional correctness, reference-based metrics, reference-free metrics, and rule-based metrics.

5. The system of claim 1, wherein the processor performs a series of actions on each response to determine whether or not a selected response has at least a threshold probability of qualifying as the most probable ground truth response and, when the selected response does not have the at least a threshold probability, a rank is not determined for the selected response.

6. The system of claim 5, wherein the processor analyzes selected first and second responses and, when the first and second responses fail to have the at least a threshold probability, the processor combines portions of the first and second responses to form an aggregate response having the at least a threshold probability.

7. The system of claim 1, wherein the processor generates, for a selected response of each of the multiple responses, a response evaluation and learning input comprising a reason for the response not being selected as the most probable ground truth response, and provides the respective response evaluation and learning input to the LLM generating the selected response.

8. The system of claim 1, wherein the processor generates, for the response selected as the most probable ground truth response, a level of similarity or difference relative to the ground truth and uses the level of similarity or difference as a self-learning input for a future rank determination.

9. A method comprising:
receiving a prompt;
providing the prompt to multiple large language models (LLMs), the multiple LLMs being trained on different datasets and having different knowledge and capabilities;
receiving multiple responses from the multiple LLMs;
determining a rank for each of the multiple responses, the rank indicating a level of confidence of the corresponding response representing a ground truth;
comparing the ranks of the multiple responses; and
selecting the response having the best rank as the most probable ground truth response.

10. The method of claim 9, wherein the multiple LLMs execute the prompt in parallel, wherein the prompt is a command to perform one or more of the following: generate text, generate machine coding, provide a response to a query, translate to a different language, and generate creative content, and further comprising:
selecting the multiple LLMs from among a larger plurality of LLMs based on analysis of the prompt.

11. The method of claim 9, wherein the rank comprises a cosine similarity score and wherein the rank determining comprises:
transforming the prompt into a plurality of vectors, each vector corresponding to a portion of the prompt and being derived from an embedding vector and a context vector;
transforming, by one or more multiple parallel self-attention layer and normalization layers, the plurality of vectors into a continuous representation of the prompt;
transforming, by a masked multi-head attention layer, multi-head attention layer, and position-wise feed-forward network, the continuous representation into an output comprising a weight associated with a selected ranking criterion for the response.

12. The method of claim 11, wherein each response is ranked based on a plurality of criteria, wherein each criterion of the plurality of criteria is assigned a weight, wherein the ranking for a selected response is derived from the weights assigned to the plurality of criteria, and wherein the plurality of criteria comprise a plurality of space complexity, time complexity, space-time complexity, clarity, maintainability, algorithmic complexity, readability, efficiency, reusability, extensibility, functional correctness, reference-based metrics, reference-free metrics, and rule-based metrics.

13. The method of claim 9, further comprising:
performing a series of actions on each response to determine whether or not a selected response has at least a threshold probability of qualifying as the most probable ground truth response and, when the selected response does not have the at least a threshold probability, not determining a rank for the selected response.

14. The method of claim 13, further comprising:
analyzing selected first and second responses and, when the first and second responses fail to have the at least a threshold probability, combining portions of the first and second responses to form an aggregate response having the at least a threshold probability.

15. The method of claim 9, further comprising:
generating, for a selected response of each of the multiple responses, a response evaluation and learning input comprising a reason for the response not being selected as the most probable ground truth response, and providing the respective response evaluation and learning input to the LLM generating the selected response.

16. The method of claim 8, wherein the processor generates, for the response selected as the most probable ground truth response, a level of similarity or difference relative to ground truth and uses the level of similarity or difference as a self-learning input for a future rank determination.

17. A system comprising:
a processor; and
a memory storing instructions thereon that, when executed by the processor, cause the processor to:
receive a prompt, wherein the prompt is a command to perform one or more of the following: generate text, generate machine coding, provide a response to a query, translate to a different language, and generate creative content;
select multiple LLMs from among a larger plurality of LLMs based on analysis of the prompt;
provide the prompt to the multiple large language models (LLMs) to cause the LLMs to execute the prompt in parallel, the multiple LLMs being trained on different datasets and having different knowledge and capabilities;
receive multiple responses from the multiple LLMs;
determine a rank for each of the multiple responses, the rank indicating a level of confidence of the corresponding response representing a ground truth;
compare the ranks of the multiple responses; and
select the response having the best rank as the most probable ground truth response.

18. The system of claim 17, wherein in determining the rank the processor:
transform the prompt into a plurality of vectors, each vector corresponding to a portion of the prompt and being derived from an embedding vector and a context vector;
transform, by one or more multiple parallel self-attention layer and normalization layers, the plurality of vectors into a continuous representation of the prompt;
transform, by a masked multi-head attention layer, multi-head attention layer, and position-wise feed-forward network, the continuous representation into an output comprising a weight associated with a selected ranking criterion for the response.

19. The system of claim 18, wherein each response is ranked based on a plurality of criteria, wherein each criterion of the plurality of criteria is assigned a weight, wherein the ranking for a selected response is derived from the weights assigned to the plurality of criteria, and wherein the plurality of criteria comprise a plurality of space complexity, time complexity, space-time complexity, clarity, maintainability, algorithmic complexity, readability, efficiency, reusability, extensibility, functional correctness, reference-based metrics, reference-free metrics, and rule-based metrics.

20. The system of claim 17, wherein the processor performs a series of actions on each response to determine whether or not a selected response has at least a threshold probability of qualifying as the most probable ground truth response and, when the selected response does not have the at least a threshold probability, a rank is not determined for the selected response.
